(19) United States
(12) Patent Application Publication
(10) Pub. No.: US 2024/0052199 A1
(43) Pub. Date: Feb. 15, 2024

(54) INSULATED ELECTRICAL WIRE AND PRODUCTION METHOD THEREFOR

(71) Applicants: SUMITOMO ELECTRIC INDUSTRIES, LTD., Osaka (JP); SUMITOMO ELECTRIC WINTEC, INC., Shiga (JP)

(72) Inventors: Hideaki SAITO, Osaka (JP); Takuya MURAKAMI, Osaka (JP); Masaaki YAMAUCHI, Osaka (JP)

(73) Assignees: SUMITOMO ELECTRIC INDUSTRIES, LTD., Osaka (JP); SUMITOMO ELECTRIC WINTEC, INC., Shiga (JP)

(21) Appl. No.: 18/270,884

(22) PCT Filed: Jan. 19, 2022
(86) PCT No.: PCT/JP2022/001811

§ 371 Date: Jul. 5, 2023

(30) Foreign Application Priority Data
Mar. 8, 2021 (JP) 2021-036490

(51) Int. Cl. C09D 179/08; H01B 3/30; H01B 13/00; H01B 13/06; C08G 73/10; C08K 3/36; C08K 3/22; C09D 7/61; C09D 7/40; C09D 7/20

(52) U.S. Cl. CPC C09D 179/08; H01B 3/306; H01B 13/0016; H01B 13/06; C08G 73/1071; C08G 73/1042; C08K 3/36; C08K 3/22; C09D 7/61; C09D 7/69; C09D 7/68; C09D 7/67; C09D 7/20; C08K 2003/2227; C08K 2201/005; C08K 2201/011

(57) ABSTRACT

An insulated wire comprising a conductor and an insulating layer covering the conductor, wherein: the insulating layer comprises a resin and a first filler; the resin comprises a polyimide; the first filler is present in the form of a primary particle or a secondary particle having a plurality of the primary particles aggregated; the primary particle is a silica or alumina particle; the secondary particle has a particle diameter of 0.03 μm or more and 5 μm or less; and the percentage of the total area of the secondary particles to the sum of the total area of the primary particles and the total area of the secondary particles in the cross section of the insulated wire is 50% or more.

### TECHNICAL FIELD

The present disclosure relates to an insulated wire and a production method therefor. The present application claims priority from Japanese Patent Application No. 2021-036490 filed on Mar. 8, 2021, the content of which is incorporated herein by reference in its entirety.

### BACKGROUND ART

Insulated wires including a conductor and an insulating layer covering the conductor has been conventionally used in motors, transformers, and the like.

### CITATION LIST

### Patent Literature

PTL 1: Japanese Patent Laying-Open No. 2008-251295
PTL 2: Japanese Patent Laying-Open No. 2009-140878
PTL 3: Japanese Patent Laying-Open No. 2010-040320

### SUMMARY OF INVENTION

The insulated wire of the present disclosure is an insulated wire comprising a conductor and an insulating layer covering the conductor, wherein:

the insulating layer comprises a resin and a first filler:

the resin comprises a polyimide;

the first filler is present in the form of a primary particle or a secondary particle having a plurality of the primary particles aggregated;

the primary particle is a silica or alumina particle;

the secondary particle has a particle diameter of 0.03 μm or more and 5 μm or less; and

the percentage of the total area of the secondary particles to the sum of the total area of the primary particles and the total area of the secondary particles in the cross section of the insulated wire is 50% or more.

### BRIEF DESCRIPTION OF DRAWINGS

FIG. 1 is a cross-sectional photomicrograph illustrating one aspect of the insulated wire of the present disclosure.

FIG. 2 is a schematic sectional (cross-sectional) view illustrating one aspect of the insulated wire of the present disclosure.

FIG. 3 is a schematic sectional (cross-sectional) view further illustrating one aspect of the insulated wire of the present disclosure.

FIG. 4 is a schematic enlarged view of region IV in FIG. 3.

### DETAILED DESCRIPTION

### Problem to be Solved by the Present Disclosure

When a voltage is suddenly applied to insulated wires, a small discharge (surge) occurs between the insulated wires. This surge is problematic because it causes accelerates dielectric breakdown. The insulated wires are thus required to be improved in the property of suppressing the dielectric breakdown caused by the surge (hereinafter referred to as “surge resistance”).

Japanese Patent Laying-Open No. 2008-251295 (PTL 1) discloses that an insulated wire having at least two insulating layers on a conductor can be improved in surge resistance by incorporating inorganic compound particles into at least one of the insulating layers (insulating layer A) and setting the thickness of the insulating layer A within a certain range.

Japanese Patent Laying-Open No. 2009-140878 (PTL 2) discloses a varnish containing silica particulates having a nano-sized hollow structure. It is described that an insulated wire can be improved in surge resistance by producing the insulated wire with the varnish.

Japanese Patent Laying-Open No. 2010-040320 (PTL 3) discloses a varnish containing a certain amount of phenyltrialkoxysilane. It is described that an insulated wire can be improved in surge resistance by producing the insulated wire with the varnish.

However, further improvement in surge resistance has been required in recent years.

Accordingly, an object of the present disclosure is to provide an insulated wire excellent in surge resistance.

### Advantageous Effect of the Present Disclosure

According to the present disclosure, an insulated wire excellent in surge resistance can be provided.

### DESCRIPTION OF EMBODIMENTS

The embodiments of the present disclosure are first listed and described.

[1] The insulated wire of the present disclosure is an insulated wire comprising a conductor and an insulating layer covering the conductor, wherein:

the insulating layer comprises a resin and a first filler;

the resin comprises a polyimide;

the first filler is present in the form of a primary particle or a secondary particle having a plurality of the primary particles aggregated;

the primary particle is a silica or alumina particle;

the secondary particle has a particle diameter of 0.03 μm or more and 5 μm or less; and

the percentage of the total area of the secondary particles to the sum of the total area of the primary particles and the total area of the secondary particles in the cross section of the insulated wire is 50% or more.

For a conventional insulated wire, a phenomenon has been observed in which, when the insulated wire is overheated by the heat evolved due to the generation of a surge, a resin contained in an insulating layer of the insulated wire is thermally decomposed and sublimated outside the insulating layer. Therefore, when the surge has been generated repeatedly, the insulating layer of the insulated wire has been sometimes eroded, eventually leading to dielectric breakdown. For the insulated wire of the present disclosure, sublimation of the resin can be physically suppressed by setting the particle diameter of the secondary particle (first filler) in the insulating layer within a certain range and setting the area percentage of the secondary particles (first filler) in the cross section of the insulated wire within a certain range. As a result, dielectric breakdown due to the surge can be suppressed. That is, the present disclosure can provide an insulated wire excellent in surge resistance.

In addition, a polyimide is excellent in toughness. Therefore, the insulated wire of the present disclosure comprises the polyimide in the resin, and thereby is excellent in toughness.

[2] The percentage of the total area of the secondary particles having a particle diameter of 0.2 μm or more and 1 μm or less to the total area of the secondary particles in the cross section is preferably 30% or more. Thereby, the insulated wire can be further increased in surge resistance.

[3] The percentage of the mass of the first filler to the mass of the insulating layer is preferably 5% or more and 30% or less. Thereby, the insulated wire can be further increased in surge resistance.

[4] The polyimide is preferably a polymer of an acid dianhydride and a diamine compound. Thereby, the insulated wire can be sufficiently provided with an excellent surge resistance and an excellent toughness of the insulating layer in combination.

[5] It is preferred that the acid dianhydride is either one or both of pyromellitic dianhydride and 3,3′,4,4′-biphenyltetracarboxylic dianhydride; and the diamine compound is 4,4′-oxydianiline. Thereby, the insulated wire can be sufficiently provided with a superior surge resistance and a superior toughness of the insulating layer in combination.

[6] It is preferred that the acid dianhydride is composed of pyromellitic dianhydride and 3,3′,4,4′-biphenyltetracarboxylic dianhydride; the pyromellitic dianhydride is contained in an amount of 10 mol % or more and 50 mol % or less; and the 3,3′,4,4′-biphenyltetracarboxylic dianhydride is contained in an amount of 50 mol % or more and 90 mol % or less.

ATF (Automatic Transmission Fluid) is used in a vehicle transmission and the like. Thus, the insulated wire may come into contact with the ATF when used in a vehicle motor or the like. When a conventional insulated wire comes into contact with the ATF, hydrolysis of the resin contained in the insulating layer constituting the insulated wire may be accelerated and cracking may occur in the insulating layer.

Polyimide is generally poor in ATF resistance because it is susceptible to hydrolysis with the moisture in the ATF. However, the acid dianhydride is composed of pyromellitic dianhydride and 3,3′,4,4′-biphenyltetracarboxylic dianhydride; the pyromellitic dianhydride is contained in an amount of 10 mol % or more and 50 mol % or less; and the 3,3′,4,4′-biphenyltetracarboxylic dianhydride is contained in an amount of 50 mol % or more and 90 mol % or less, so that the acid dianhydride can provide the insulating layer with hydrolysis resistance and can thereby provide the insulated wire with an excellent ATF resistance. In the present specification, the property of suppressing hydrolysis of the insulating layer caused by contact of the insulated wire with ATF is defined as “ATF resistance”.

[7] The method for producing an insulated wire of the present disclosure is a method for producing the above-described insulated wire, comprising, in the following order:

a first step of preparing the conductor and an insulating varnish;

a second step of coating the conductor on an outer peripheral surface thereof with the insulating varnish; and

a third step of baking the insulating varnish onto the conductor;

wherein:

the first step comprises step A of preparing the conductor and step B of preparing the insulating varnish;

in the step B, the insulating varnish is prepared by mixing a solvent, the first filler and the resin or a resin precursor thereof;

the solvent is N-methyl-2-pyrrolidone, N,N-dimethylacetamide or a mixture thereof; and

the primary particle in the first filler has a particle diameter of 0.01 μm or more and 0.1 μm or less. Thereby, the insulated wire excellent in surge resistance can be produced.

[8] The third step is preferably performed at 300° C. or more and 700° C. or less for 0.1 minutes or more and 5 minutes or less. Thereby, the insulated wire superior in surge resistance can be produced.

[9] The insulating varnish preferably has a resin solid content concentration of 10% by mass or more and 40% by mass or less. Thereby, the insulated wire superior in surge resistance can be produced.

[10] The percentage of the mass of the first filler to the mass of the resin solid content in the insulating varnish is preferably 5% or more and 35% or less. Thereby, the insulated wire superior in surge resistance can be produced.

### DETAILED DESCRIPTION OF EMBODIMENTS

Hereinafter, an embodiment of the present disclosure (hereinafter referred to as “the present embodiment”) will be described. However, the present embodiment is not limited thereto. The expression “A to B” as used in the present specification means the upper and lower limits of the range (that is, A or more and B or less), wherein when the unit is described only for B but not for A, the unit of A is the same as that of B.

<<Insulated Wire>>

FIG. 2 is a schematic sectional (cross-sectional) view illustrating one aspect of the insulated wire of the present disclosure. An insulated wire 10 (hereinafter sometimes simply referred to “insulated wire”) in the present disclosure comprises a conductor 11 and an insulating layer 12 covering conductor 11 (FIG. 2). As used herein, the term “covering” preferably means covering the entire surface of conductor 11, but even if a part of the surface of conductor 11 is not covered with insulating layer 12, it does not depart from the scope of the present disclosure, as long as the effect of the present disclosure is provided. The insulated wire of the present disclosure may further comprise a base layer, an adhesion layer, a protective layer, a surface layer, a lubricating layer, and the like.

The insulated wire is linear in shape. The cross section of the insulated wire described below means a section which appears by cutting the insulated wire along a plane perpendicular to the longitudinal direction thereof. The cross section of the insulated wire may be circular (including substantially circular) or rectangular in shape.

<Conductor>

The insulated wire according to the present embodiment comprises a conductor, as described above. The conductor refers to an electrical conductor. The material constituting the conductor is preferably a metal which is high in conductivity and high in mechanical strength. Specific examples of the metal include copper, a copper alloy, aluminum, an aluminum alloy, nickel, silver, soft iron, steel and stainless steel. The conductor may be a strand linearly formed from any one of these metals, may be a covered wire having the surface of the strand covered with another metal, or may be a twisted wire having a plurality of strands twisted together. Examples of the covered wire include, but are not limited to, a nickel-covered copper wire, a silver-covered copper wire, a silver-covered aluminum wire and a copper-covered steel wire.

The conductor is not particularly limited in shape, but may be appropriately selected from a round wire, a rectangular wire and the like depending on intended use, electrical properties and the like of the insulated wire. That is, the cross-section of the conductor may be circular (including substantially circular) or rectangular in shape in the cross section of the insulated wire. In addition, the conductor is not particularly limited in its diameter and outer perimeter, but can be appropriately selected depending on intended use, electrical properties and the like of the insulated wire.

The lower limit of the cross-sectional area of the conductor part in the cross section of the insulated wire is preferably 0.01 mm² or more and more preferably 0.1 mm² or more, and the upper limit thereof is preferably 40 mm² or less and more preferably 20 mm² or less. If the cross-sectional area of the conductor part in the cross section of the insulated wire is not 0.01 mm² or more, the proportion of the volume of the insulating layer to the volume of the conductor increases, and for example, the volume efficiency of the coil formed using the insulated wire may decrease. If the cross-sectional area of the conductor part in the cross-section of the insulated wire exceeds 40 mm² or less, the copper loss due to the eddy current may increase, resulting in reduction in the output efficiency of the coil.

<Insulating Layer>

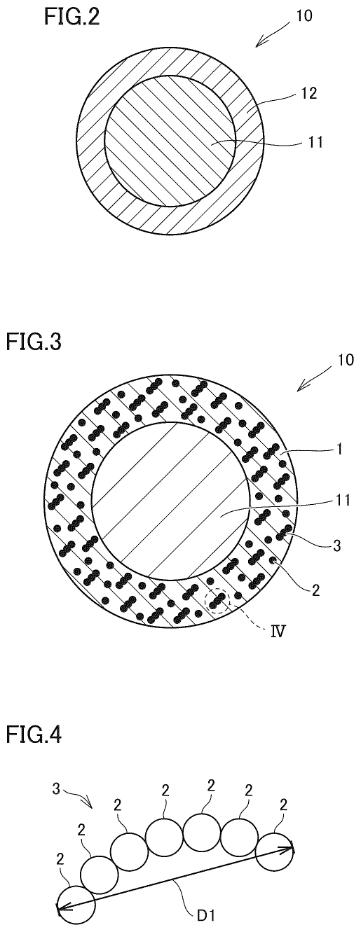

FIG. 3 is a schematic sectional (cross-sectional) view further illustrating one aspect of the insulated wire of the present disclosure. Insulating layer 12 comprises a resin 1 and a first filler (FIG. 3). The insulating layer may also further comprise a curing agent, other additives and a second filler.

The curing agent has a function of curing the resin. Specific examples of the curing agent include alicyclic acid anhydrides, aliphatic acid anhydrides and aromatic acid anhydrides such as imidazole, triethylamine, titanium-based compounds, isocyanate-based compounds, blocked isocyanates, urea, melamine compounds, acetylenic derivatives and methyltetrahydrophthalic anhydride. Examples of the titanium-based compounds include tetrapropyl titanate, tetraisopropyl titanate, tetramethyl titanate, tetrabutyl titanate and tetrahexyl titanate. Illustrative examples of the isocyanate-based compounds include aromatic diisocyanates such as tolylene diisocyanate (TDI), diphenylmethane diisocyanate (MDI), p-phenylene diisocyanate and naphthalene diisocyanate; aliphatic diisocyanates having 3 to 12 carbon atoms such as hexamethylene diisocyanate (HDI), 2,2,4-trimethylhexane diisocyanate and lysine diisocyanate; alicyclic isocyanates having 5 to 18 carbon atoms such as 1,4-cyclohexane diisocyanate (CDI), isophorone diisocyanate (IPDI), 4,4′-dicyclohexylmethane diisocyanate (hydrogenated MDI), methylcyclohexane diisocyanate, isopropylidene dicyclohexyl-4,4′-diisocyanate, 1,3-diisocyanatomethylcyclohexane (hydrogenated XDI), hydrogenated TDI, 2,5-bis(isocyanatomethyl)-bicyclo[2,2,1]heptane and 2,6-bis(isocyanatomethyl)-bicyclo[2,2,1]heptane; aliphatic diisocyanates having an aromatic ring such as xylylene diisocyanate (XDI) and tetramethylxylylene diisocyanate (TMXDI); and modified products thereof. Illustrative examples of the blocked isocyanates include diphenylmethane-4,4′-diisocyanate (MDI), diphenylmethane-3,3′-diisocyanate, diphenylmethane-3,4′-diisocyanate, diphenyl ether-4,4′-diisocyanate, benzophenone-4,4′-diisocyanate, diphenylsulfone-4,4′-diisocyanate, tolylene-2,4-diisocyanate, tolylene-2,6-diisocyanate, naphthylene-1,5-diisocyanate, m-xylylene diisocyanate and p-xylylene diisocyanate. Illustrative examples of the melamine compounds include methylated melamine, butylated melamine, methylolated melamine and butyrolated melamine. Illustrative examples of the acetylenic derivatives include ethynylaniline and ethynylphthalic anhydride. The curing agent to be used is preferably any nitrogen-containing compound such as a melamine compound. Such a curing agent is used because it has a high curing acceleration effect.

Examples of the other additives include an antioxidant, a UV protectant and a surface lubricant.

The second filler refers to fillers other than the first filler, and may comprise one or more of such fillers.

The thickness of the insulating layer is preferably 5 μm or more and preferably 200 μm or less. If the thickness of the insulating layer is less than 5 μm, the insulating layer tends to be subject to failure and insulation of the conductor may be thereby insufficient. If the thickness of the insulating layer exceeds 200 μm, the volume efficiency of the coil or the like formed using the insulated wire tends to be low.

The thickness of the insulating layer refers to the average value of the thickness of the insulating layer in the cross section of the insulated wire. Specifically, the thickness of the insulating layer is determined by polishing the cross section at each of any five points in the longitudinal direction of the wire to expose a plat cross section and subjecting it to imaging through a microscope. An average value is calculated from the values determined at the five points, and this average value can be taken as the thickness of the insulating layer.

(Resin)

The resin comprises a polyimide. The polyimide is a polymer having an imide linkage (—CONCO—) in its backbone. The polyimide is known to be excellent in heat resistance. In addition, the polyimide can prevent the insulating layer from breaking due to high toughness, even if the insulating layer comprises the secondary particle described below. The polyimide is preferably a polymer of an acid dianhydride and a diamine compound. In other words, the polyimide is preferably a polymer having a structure in which a building block derived from an acid dianhydride and a building block derived from a diamine compound are repeatedly bonded. As used herein, the term “acid dianhydride” refers to a compound having a structure in which two water molecules are eliminated from four carboxylic acid groups present in its own molecule of the acid (that is, a structure in which two carboxylic acid group pairs of two carboxylic acid groups adjacent to each other in one molecule are present and one water molecule is eliminated from each pair of carboxylic acid groups). The expression “comprising a polyimide” means that a resin may comprises a resin(s) other than the polyimide. Examples of the other resin include thermosetting resins such as polyvinyl formal resins, polyurethane resins, alkyl resins, epoxy resins, phenoxy resins, polyester resins, polyesterimide resins, polyesteramideimide resins and polyamideimide resins; and thermoplastic resins such as polyetherimide resins, polyetheretherketone resins and polyethersulfone resins.

Examples of the acid dianhydride include pyromellitic dianhydride (PMDA), 3,3′,4,4′-biphenyltetracarboxylic dianhydride (BPDA), 2,2′,3,3′-benzophenonetetracarboxylic dianhydride, 3,3′,4,4′-benzophenonetetracarboxylic dianhydride, 4,4′-oxydiphthalic dianhydride, 2,2-bis(3,4-dicarboxyphenyl)propane dianhydride, 2,2-bis(2,3-dicarboxyphenyl)propane dianhydride, 1,1-bis(3,4-dicarboxyphenyl)ethane dianhydride, 1,1-bis(2,3-dicarboxyphenyl)ethane dianhydride, bis(3,4-dicarboxyphenyl)methane dianhydride, bis(2,3-dicarboxyphenyl)methane dianhydride, bis(3,4-dicarboxyphenyl)sulfone dianhydride, bis(3,4-dicarboxyphenyl)ether dianhydride, 1,2,5,6-naphthalenetetracarboxylic dianhydride and 2,3,6,7-naphthalenetetracarboxylic dianhydride.

Examples of the diamine compound include 4,4′-oxydianiline (ODA), m-phenylenediamine, silicone diamine, bis(3-aminopropyl)etherethane, 3,3′-diamino-4,4′-dihydroxydiphenylsulfone (SO₂—HOAB), 4,4′-diamino-3,3′-dihydroxybiphenyl (HOAB), 2,2-bis[4-(4-aminophenoxy)phenyl]hexafluoropropane (HOCF₃AB), siloxane diamine, bis(3-aminopropyl)etherethane, N,N-bis(3-aminopropyl)ether, 1,4-bis(3-aminopropyl)piperazine, isophoronediamine, 1,3′-bis(aminomethyl)cyclohexane, 3,3′-dimethyl-4,4′-diaminodicyclohexylmethane, 4,4′-methylenebis(cyclohexylamine), 4,4′-diaminodiphenyl ether (DDE), 3,4′-diaminodiphenyl ether (m-DDE), 3,3′-diaminodiphenyl ether, 4,4′-diamino-diphenylsulfone (p-DDS), 3,4′-diamino-diphenylsulfone, 3,3′-diamino-diphenylsulfone, 2,4′-diaminodiphenyl ether, 1,3-bis(4-aminophenoxy)benzene (m-TPE), 1,3-bis(3-aminophenoxy)benzene (APB), 2,2-bis[4-(4-aminophenoxy)phenyl]propane (BAPP), 2,2-bis[4-(4-aminophenoxy)phenyl]hexafluoropropane (HF-BAPP), bis[4-(4-aminophenoxy)phenyl]sulfone (p-BAPS), bis[4-(3-aminophenoxy)phenyl]sulfone (m-BAPS), 4,4′-bis(4-aminophenoxy)biphenyl (BAPB), 1,4-bis(4-aminophenoxy)benzene (p-TPE), 4,4′-diaminodiphenyl sulfide (ASD), 3,4′-diaminodiphenyl sulfide, 3,3′-diaminodiphenyl sulfide, 3,3′-diamino-4,4′-dihydroxydiphenyl sulfone, 2,4-diaminotoluene (DAT), 2,5-diaminotoluene, 3,5-diaminobenzoic acid (DABz), 2,6-diaminopyridine (DAPy), 4,4′-diamino-3,3′-dimethoxybiphenyl (CH₃OAB), 4,4′-diamino-3,3′-dimethylbiphenyl (CH₃AB) and 9,9′-bis(4-aminophenyl)fluorene (FDA).

It is preferred that the acid dianhydride is either one or both of pyromellitic dianhydride and 3,3′,4,4′-biphenyltetracarboxylic dianhydride; and the diamine compound is 4,4′-oxydianiline. Thereby, the interaction between polyimide molecules works strongly, so that the insulated wire can be provided with a particularly excellent surge resistance and a particularly excellent toughness of the insulating layer in combination.

It is preferred that the acid dianhydride is composed of pyromellitic dianhydride and 3,3′,4,4′-biphenyltetracarboxylic dianhydride; the pyromellitic dianhydride is contained in an amount of 10 mol % or more and 50 mol % or less; and the 3,3′,4,4′-biphenyltetracarboxylic dianhydride is contained in an amount of 50 mol % or more and 90 mol % or less. Thereby, the hydrolysis resistance can be improved, so that the insulated wire can be provided with a particularly excellent ATF resistance.

It can be determined, by alkali hydrolysis of the coating component followed by analysis by ¹H NMR (Proton Nuclear Magnetic Resonance), that the acid dianhydride is composed of pyromellitic dianhydride and 3,3′,4,4′-biphenyltetracarboxylic dianhydride; the pyromellitic dianhydride is contained in an amount of 10 mol % or more and 50 mol % or less; and the 3,3′,4,4′-biphenyltetracarboxylic dianhydride is contained in an amount of 50 mol % or more and 90 mol % or less.

The diamine compound is preferably 4,4′-oxydianiline. Thereby, the hydrolysis resistance can be improved, so that the insulated wire can be provided with a particularly excellent ATF resistance.

(First Filler)

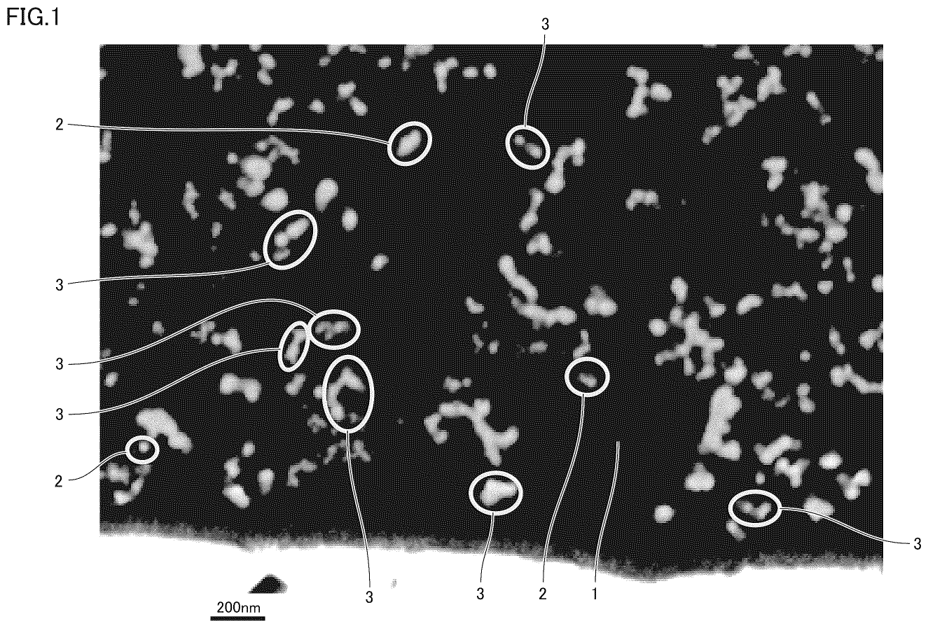

FIG. 3 is a schematic sectional (cross-sectional) view further illustrating one aspect of the insulated wire of the present disclosure. FIG. 4 is a schematic enlarged view of region IV in FIG. 3. The first filler is present in the form of a primary particle 2 or a secondary particle 3 having a plurality of the primary particles aggregated (FIG. 3). As used herein, the term “aggregated” means a state in which a plurality of primary particles 2 is agglomerated, for example, in a beaded manner so that a larger particle than primary particle 2 is formed (FIG. 4). In this case, the state of contact between the primary particles in secondary particle 3 may be, but not particularly limited to, a state in which the primary particles are only in contact in appearance, or a state involving interaction such as Van der Waals force or physical/chemical bonding. Therefore, when observing the cross section of the insulated wire using a scanning electron microscopy (SEM), two or more primary particles 2, which are observed in contact with each other in the observation field, shall be interpreted as secondary particle 3. FIG. 1 is a cross-sectional photomicrograph of the insulated wire. It is understood, from FIG. 1, that in the insulating layer, the first filler is present in the form of primary particle 2 or secondary particle 3 having a plurality of the primary particles aggregated.

As used herein, the expression “in contact with” means that the distance between the adjacent primary particles is 0.02 μm or less. As used herein, the expression “distance between the adjacent primary particles” means, with respect to two adjacent primary particles, the length of the shortest line segment among line segments (straight-line segments) connecting a point located on the outline of one primary particle and a point located on the outline of another other primary particle.

The primary particle is a silica or alumina particle. Thus, the secondary particle may be composed of only either one of silica or alumina, or may be composed of both silica and alumina.

The primary particle is not particularly limited in shape. The shape may be any shape such as an irregular shape, a substantially spherical shape, a rugby ball shape or a polygonal shape. The particle diameter of the primary particle is defined as the distance between the two most distant points on the outline of one primary particle in the cross section of the insulated wire. The particle diameter of the primary particle means the average particle diameter. The particle diameter of the primary particle can be determined by observing the cross section of the insulated wire using a scanning electron microscopy (SEM) and thereby measuring the particle diameter of each of any 50 primary particles on the SEM image, and then calculating the average value of the particle diameters of the 50 primary particles (average particle diameter).

The particle diameter of the primary particle is not particularly limited but is preferably 0.01 μm or more and 0.1 μm or less.

Therefore, the secondary particle may be composed of only the primary particles, or may comprise other components.

The secondary particle is not particularly limited in shape. The shape may be any shape such as an irregular shape, a substantially spherical shape, a rugby ball shape or a polygonal shape. The particle diameter of secondary particle 3 is defined as a distance D1 between the two most distant points on the outline of one secondary particle 3 in the cross section of the insulated wire (FIG. 4). The particle diameter of the secondary particle means the average particle diameter. The particle diameter of the secondary particle can be determined by observing the cross section of the insulated wire using a scanning electron microscopy (SEM) and thereby measuring the particle diameter of each of any 50 secondary particles on the SEM image, and then calculating the average value of the particle diameters of the 50 secondary particles (average particle diameter).

The particle diameter of the secondary particle is 0.03 μm or more and 5 μm or less. Thereby, sublimation of the resin can be physically suppressed, so that the insulated wire can be provided with an excellent surge resistance and a suitable toughness in combination. The particle diameter of the secondary particle is preferably 0.1 μm or more, more preferably 0.15 μm or more, and still more preferably 0.2 μm or more. The particle diameter of the secondary particle is also preferably 3.0 μm or less, more preferably 1.5 μm or less, and still more preferably 1.0 μm or less. The particle diameter of the secondary particle is also preferably 0.1 μm or more and 3.0 μm or less, more preferably 0.15 μm or more and 1.5 μm or less, and still more preferably 0.2 μm or more and 1.0 μm or less.

The percentage of the total area of the secondary particles to the sum of the total area of the primary particles and the total area of the secondary particles (hereinafter also referred to as “secondary particle area occupation percentage (%)”) in the cross section of the insulated wire is desirably 50% or more. As used herein, the term “area of the primary particles” means the area of the primary particles other than the primary particles constituting the secondary particles. Thereby, sublimation of the resin is physically suppressed by the secondary particles, so that dielectric breakdown due to erosion of the resin can be prevented and the insulated wire can be provided with an excellent surge resistance. The secondary particle area occupation percentage (° %) is preferably 50% or more, more preferably 55% or more, and still more preferably 60% or more. The secondary particle area occupation percentage (%) is also preferably 90% or less. This can prevent the particle diameter of the particles from exceeding 5 μm due to excessive agglomeration of the particles and can avoid a decrease in toughness of the insulating layer due to an increase in the particle diameter, so that the insulated wire can be provided with a suitable toughness. The secondary particle area occupation percentage (%) is more preferably 80% or less, and still more preferably 75% or less. The secondary particle area occupation percentage (%) is preferably 50% or more and 90% or less, more preferably 55% or more and 80% or less, and still more preferably 60% or more and 75% or less. The secondary particle area occupation percentage (%) can be determined by observing the cross section of the insulated wire using a scanning electron microscopy (SEM) and calculating the total area of the primary particles and the total area of the secondary particles in a predetermined region with an image processing software (“Winroof” from MITANI CORPORATION).

The percentage of the total area of the secondary particles having a particle diameter of 0.2 μm or more and 1 μm or less to the total area of the secondary particles (hereinafter also referred to as “the area occupation percentage (%) of secondary particles having a particle diameter of 0.2 to 1 μm”) in the cross section of the insulated wire is preferably 30% or more. Thereby, sublimation of the resin is easily physically suppressed by the secondary particles, so that the insulated wire can be provided with a particularly excellent surge resistance. The area occupation percentage (%) of secondary particles having a particle diameter of 0.2 to 1 μm is preferably 50% or more, more preferably 55% or more, and still more preferably 60% or more. The area occupation percentage (%) of secondary particles having a particle diameter of 0.2 to 1 μm is also preferably 90% or less. This can prevent the particle diameter of the particles from exceeding 5 μm due to excessive agglomeration of the particles and can avoid a decrease in toughness of the insulating layer due to an increase in the particle diameter, so that the insulated wire can be provided with a suitable toughness. The area occupation percentage (%) of secondary particles having a particle diameter of 0.2 to 1 μm is preferably 80% or less, and still more preferably 75% or less. The area occupation percentage (%) of secondary particles having a particle diameter of 0.2 to 1 μm is preferably 50% or more and 90% or less, more preferably 55% or more and 80% or less, and still more preferably 60% or more and 75% or less. The area occupation percentage (%) of secondary particles having a particle diameter of 0.2 to 1 μm can be determined by observing the cross section of the insulated wire using a scanning electron microscopy (SEM) and calculating the total area of the secondary particles occupying the area of a predetermined region and the total area of secondary particles having a particle diameter of 0.2 μm or more and 1 μm or less with an image processing software (“Winroof” from MITANI CORPORATION).

The percentage of the mass of the first filler to the mass of the insulating layer is preferably 5% or more and 30% or less. Thereby, the insulated wire can be sufficiently provided with an excellent surge resistance and a suitable toughness in combination. If the percentage of the mass of the first filler to the mass of the insulating layer is less than 5%, the insulated wire tends to be difficult to exhibit a sufficient surge resistance. In contrast, if the percentage of the mass of the first filler to the mass of the insulating layer exceeds 30% or less, the insulating layer tends to deteriorate in flexibility. The percentage of the mass of the first filler to the mass of the insulating layer is preferably 5% or more, more preferably 10% or more, and still more preferably 15% or more. The percentage of the mass of the first filler to the mass of the insulating layer is also preferably 30% or less, more preferably 26% or less, and still more preferably 23% or less. The percentage of the mass of the first filler to the mass of the insulating layer is also preferably 5% or more and 30% or less, more preferably 10% or more and 26% or less, and still more preferably 15% or more and 23% or less. The percentage of the mass of the first filler to the mass of the insulating layer can be determined by measuring the residue of the insulating layer after heating (which is taken as the weight of the filler) by thermogravimetry.

Since the insulated wire according to the present disclosure has an excellent surge resistance, electrical equipment using the insulated wire can be suppressed in dielectric breakdown caused by surge, even if used under a high voltage. Examples of such electrical equipment include motors and transformers.

<<Production Method for Insulated Wire>>

The insulated wire according to the present disclosure can be produced by the following method for producing the insulated wire, for example, from the viewpoint of production in a high yield. That is, the method for producing an insulated wire according to the present embodiment comprises, in the following order: a step of preparing a conductor and an insulating varnish (first step); a step of coating the conductor on an outer peripheral surface thereof with the insulating varnish (second step); and a step of baking the insulating varnish onto the conductor (third step). The step of preparing a conductor and an insulating varnish (first step) comprises a step of preparing the conductor (step A) and a step of preparing the insulating varnish (step B).

In the step of preparing the insulating varnish (step B), the insulating varnish is prepared by mixing a solvent, a first filler and a resin or a resin precursor thereof, and the solvent is characterized by being N-methyl-2-pyrrolidone, N,N-dimethylacetamide or a mixture thereof. The primary particle in the first filler is characterized by having a particle diameter of 0.01 μm or more and 0.1 μm or less. Furthermore, in step B, the insulating varnish is preferably prepared by mixing the solvent, the first filler and the resin or the resin precursor thereof while stirring at a stirring speed of 20 rpm or more and 500 rpm or less for a stirring time of 30 minutes or more and 180 minutes or less. The insulating varnish also preferably contains no silane coupling agent. In addition, the step of baking the insulating varnish onto the conductor (third step) is preferably performed at 300° C. or more and 700° C. or less for 0.1 minutes or more and 5 minutes or less.

The insulated wire obtained by performing step B and the third step having such features can exhibit an excellent surge resistance because it is configured as described above. Hereinafter, each step contained in the method for producing an insulated wire according to the present embodiment will be described in detail.

<First Step>

(Step A)

The step of preparing a conductor (step A) can be performed, for example, by obtaining a commercial product. The present step can be also performed by casting the metal described above as a material for the conductor, drawing it, drawing it into a wire and further softening it to obtain a conductor.

(Step B)

The step of preparing an insulating varnish (step B) can be performed by dissolving the resin described above as a material for the insulating layer or a resin precursor thereof in N-methyl-2-pyrrolidone, N,N-dimethylacetamide or a mixture thereof (a solvent) to obtain a resin solution, and dispersing, in the resin solution, a first filler in which a primary particle has a particle diameter of 0.01 μm or more and 0.1 μm or less.

Examples of the Resin Precursor Include a Polyimide Precursor.

The insulating varnish has preferably a resin solid content concentration of 10% by mass or more, more preferably 15% by mass or more, and still more preferably 20% by mass or more. The insulating varnish also has preferably a resin solid content concentration of 40% by mass or less, more preferably 35% by mass or less, and still more preferably 30% by mass or less. The insulating varnish also has preferably a resin solid content concentration of 10% by mass or more and 40% by mass or less, more preferably 15% by mass or more and 35% by mass or less, and still more preferably 20% by mass or more and 30% by mass or less. As used herein, the term “resin solid content concentration” means the concentration of the resin when the insulating varnish comprises only the resin among the resin and the resin precursor thereof; the concentration of the resin precursor when the insulating varnish comprises only the resin precursor among the resin and the resin precursor thereof; and the total concentration of both the resin and the resin precursor thereof when the insulating varnish comprises both, respectively.

The percentage of the mass of the first filler to the mass of the resin solid content in the insulating varnish is preferably 5% or more, more preferably 10% or more, and still more preferably 15% or more. The percentage of the mass of the first filler to the mass of the resin solid content in the insulating varnish is also preferably 35% or less, more preferably 30% or less, and still more preferably 25% or less. The percentage of the mass of the first filler to the mass of the resin solid content in the insulating varnish is also preferably 5% or more and 35% or less, more preferably 10% or more and 30% or less, and still more preferably 15% or more and 25% or less. As used herein, the term “mass of the resin solid content” means the mass of the resin when the insulating varnish comprises only the resin among the resin and the resin precursor thereof; the mass of the resin precursor when the insulating varnish comprises only the resin precursor among the resin and the resin precursor thereof; and the total mass of both the resin and the resin precursor thereof when the insulating varnish comprises both, respectively.

In addition to N-methyl-2-pyrrolidone, N,N-dimethylacetamide or a mixture thereof (a solvent), the resin or the resin precursor thereof and the first filler as described above, the insulating varnish may comprise other solvents, the above-described curing agent, the above-described other additives and the above-described second filler. However, the insulating varnish preferably comprises no silane coupling agent.

Any known organic solvents can be used as the other solvents. Specific examples of the other solvents include polar organic solvents such as N,N-dimethylformamide, dimethylsulfoxide, tetramethylurea, hexaethylphosphoric triamide and γ-butyrolactone; ketone-based organic solvents such as acetone, methyl ethyl ketone, methyl isobutyl ketone and cyclohexanone; ester-based organic solvents such as methyl acetate, ethyl acetate, butyl acetate and diethyl oxalate; ether-based organic solvents such as diethyl ether, ethylene glycol dimethyl ether, diethylene glycol monomethyl ether, ethylene glycol monobutyl ether (butyl cellosolve), diethylene glycol dimethyl ether and tetrahydrofuran; hydrocarbon-based organic solvents such as hexane, heptane, benzene, toluene and xylene; halogen-based organic solvents such as dichloromethane and chlorobenzene; phenolic organic solvents such as cresol and chlorophenol; and amine-based organic solvents such as pyridine. These organic solvents can be used alone or in combination of two or more.

When the solvent comprises the other solvent(s), the percentage thereof is preferably 10% by mass or more and 50% by mass or less with respect to N-methyl-2-pyrrolidone, N,N-dimethylacetamide or a mixture thereof.

Step B is preferably performed by mixing the above components while stirring at a stirring speed of 20 rpm or more and 500 rpm or less for a stirring time of 30 minutes or more and 180 minutes or less.

<Second Step>

The step of coating a conductor on an outer peripheral surface thereof with an insulating varnish (second step) is a step of coating the conductor on an outer peripheral surface thereof with the prepared varnish. The coating method is not particularly limited, and any coating method conventionally known may be used. For example, when coating dies having openings are used, the varnish can be coated in a uniform thickness and the coated varnish can have a smooth surface.

<Third Step>

The step of baking an insulating varnish onto a conductor (third step) is a step of forming an insulating layer by a baking treatment. Specifically, the conductor having the varnish coated is placed in a baking furnace to bake the varnish. The step of baking an insulating varnish onto a conductor (third step) is preferably performed at 300° C. or more and 700° C. or less for 0.1 minutes or more and 5 minutes or less.

As described above, the insulated wire comprising the conductor and the insulating layer covering the conductor is produced. The second step and the third step may be repeated until the insulating layer laminated on the surface of the conductor has a predetermined thickness.

### EXAMPLES

Hereinafter, the present disclosure will be specifically described based on the examples thereof, but the present invention will not be limited to the following examples.

<<Production of Insulated Wire>>

Each of the insulated wires of Examples 1 to 7 and Comparative Examples 1 and 2 were produced as follows. First, a conducting wire (a metal species: a tough pitch copper) with an average diameter of 1 mm was prepared (step A). Then, an acid dianhydride and a diamine compound shown in Table 1 were dissolved in N-methyl-2-pyrrolidone and reacted with each other to obtain a polyimide precursor solution (resin solution) having a concentration of 25% by weight. A first filler of silica, which has a particle diameter of a primary particle of 0.03 μm, was dispersed in the resin solution at 20% by mass of the first filler relative to the polyimide precursor (resin solid content) to prepare an insulating varnish (step B). Next, the conductor was coated on an outer peripheral surface thereof with the insulating varnish using coating dies to produce the conductor having the insulating varnish coated (second step). Thereafter, the conductor having the insulating varnish coated was placed in a baking furnace and subjected to baking at 450° C. for 90 minutes (third step). The second step and the third step were repeated a predetermined number of times to form an insulating layer having a thickness (μm) shown in Table 1 (measurement method is as described above) and thereby produce an insulated wire. By performing the above steps, each of the insulated wires of Examples 1 to 4 and 7 and Comparative Examples 1 and 2 configurated as shown in Table 1 was produced. The insulated wire of Example 5 was produced by performing the same steps as those for the insulated wire of Example 3, except that in step B, the percentage (mol %) of the acid dianhydride was changed as shown in Table 1 and the first filler was dispersed in the resin solution at 10% by mass with respect to the polyimide precursor (resin solid content). The insulated wire of Example 6 was produced by performing the same steps as those for the insulated wire of Example 5, except that in step B, the first filler was dispersed in the resin solution at 15% by mass with respect to the polyimide precursor (resin solid content) and the thickness of the insulating layer (μm) (the measurement method is as described above) was changed as shown in Table 1.

<<Determination of Percentage of Mass of First Filler to Mass of Insulating Layer>>

For each of the insulated wires of Examples 1 to 7 and Comparative Examples 1 and 2, the percentage of the mass of the first filler to the mass of the insulating layer was determined by the above-described method. The obtained results are shown in Table 1 under the row title “percentage of mass of first filler to mass of insulating layer (%)”.

<<Determination of Secondary Particle Area Occupation Percentage (%) and Area Occupation Percentage (%) of Secondary Particles Having a Particle Diameter of 0.2 to 1 μm>>

For each of the insulated wires of Examples 1 to 7 and Comparative Examples 1 and 2, the secondary particle area occupation percentage (%) and the area occupation percentage (%) of secondary particles having a particle diameter of 0.2 to 1 μm were determined by the above-described method. The obtained results are shown in Table 1 under the row title “secondary particle area occupation percentage (%)” and “area occupation percentage (%) of secondary particles having a particle diameter of 0.2 to 1 μm”, respectively.

<<Surge Resistance Test>>

Each of the insulated wires of Examples 1 to 7 and Comparative Examples 1 and 2 was subjected to a surge resistance test according to the following procedure. That is, two insulated wires were twisted to produce a twisted wire sample and the sample was evaluated, in accordance with the methods specified in JIS C 3003 and IEC 60851-5. Detailed test conditions are as follows.

### (Test Conditions)

Waveform: rectangular wave
Frequency: 20 kHz
Voltage: 1,500 V
Temperature of atmosphere: 155° C.

As used herein, the term “endurance time” means the time until a short circuit is caused as a result of dielectric breakdown between the two twisted wires (insulated wires) under the above test conditions in the endurance test. It means that the longer the endurance time, the excellent the insulated wire in surge resistance. In addition, in this test, an insulated wire with an endurance time of 45 hours or more is defined as being good in surge resistance. The test results are shown in Table 1.

TABLE 1

| | | | | | | | | Com- | Com- |
|---|---|---|---|---|---|---|---|---|---|
| | Example | Example | Example | Example | Example | Example | Example | parative | parative |
| | 1 | 2 | 3 | 4 | 5 | 6 | 7 | Example 1 | Example 2 |
| Acid dianhydride | PMDA (100) | PMDA (50) | PMDA (30) | PMDA (15) | PMDA (25) | PMDA (25) | — | PMDA (50) | PMDA (30) |
| (mol %) | — | BPDA (50) | BPDA (70) | BPDA (85) | BPDA (75) | BPDA (75) | BPDA (100) | BPDA (50) | BPDA (70) |
| Diamine | ODA (100) | ODA (100) | ODA (100) | ODA (100) | ODA (100) | ODA (100) | ODA (100) | ODA(100) | ODA (100) |
| compound | | | | | | | | | |
| (mol %) | | | | | | | | | |
| Percentage of | 20 | 20 | 20 | 20 | 10 | 15 | 20 | 20 | 20 |
| mass of first | | | | | | | | | |
| filler to mass of | | | | | | | | | |
| insulating layer | | | | | | | | | |
| (%) | | | | | | | | | |
| Thickness of | 40 | 40 | 42 | 40 | 42 | 41 | 40 | 41 | 42 |
| insulating layer | | | | | | | | | |
| (μm) | | | | | | | | | |
| Secondary particle | 50 | 62 | 60 | 73 | 63 | 60 | 70 | 43 | 35 |
| area occupation | | | | | | | | | |
| percentage (%) | | | | | | | | | |
| Arca occupation | 55 | 43 | 60 | 45 | 58 | 66 | 72 | 25 | 60 |
| percentage (%) of | | | | | | | | | |
| secondary particles | | | | | | | | | |
| having a particle | | | | | | | | | |
| diameter of 0.2 to | | | | | | | | | |
| 1 μm | | | | | | | | | |
| Surge resistance test | 50 | 51 | 100 | 105 | 55 | 76 | 80 | 13 | 21 |
| Time to dielectric | | | | | | | | | |
| breakdown (h) | | | | | | | | | |
| ATF resistance test | Present | Absent | Absent | Absent | Absent | Absent | Almost | Absent | Absent |
| Presence or | | | | | | | absent | | |
| absence of cracks | | | | | | | | | |

Abbreviations in Table 1 above are as follows.

PMDA: Pyromellitic dianhydride

BPDA: 3,3′,4,4′-Biphenyltetracarboxylic dianhydride

ODA: 4,4′-Oxydianiline

From the results in Table 1, it has found that the insulated wires of Examples 1 to 7 are superior in surge resistance than the insulated wires of Comparative Examples 1 and 2. The filler used in each of the insulated wires of Examples 1 to 7 and Comparative Examples 1 and 2 was only silica. However, since an alumina particle is high in insulating properties as with a silica particle, similar effects are expected to be exhibited when silica is replaced with alumina and when silica and alumina are used in combination.

<<ATF Resistance Test>>

Each of the insulated wires of Examples 1 to 7 and Comparative Examples 1 and 2 was subjected to an ATF resistance test according to the following procedure. That is, a winding wire sample was immersed in ATF oil containing 0.5% by mass of water in a SUS sealed container, heated in an environment of 150° C. in a sealed state for 1000 hours. Thereafter, the winding wire sample was taken out and subjected to evaluation for the presence or absence of cracks of the coating. The results are shown in Table 1.

From the results in Table 1, it has found that the insulated wires of Examples 2 to 6 are as excellent in ATF resistance as the insulated wires of Comparative Examples 1 and 2.

Although the embodiments and examples of the present invention have been described above, from the beginning, the features of each of the above-described embodiments and examples has been contemplated to be appropriately combined.

The embodiments and examples disclosed herein should be considered as exemplary and not as restrictive in all respects. The scope of the present invention is defined by the claims rather than the above description, and is intended to include all modifications within the meaning and the scope equivalent to those of the claims.

### REFERENCE SIGNS LIST

1 resin, 2 primary particle (first filler), 3 secondary particle (first filler), 10 insulated wire, 11 conductor, 12 insulating layer, D1 distance between two most distant points on outline of one secondary particle in cross section of insulated wire.

1. An insulated wire comprising a conductor and an insulating layer covering the conductor, wherein:
the insulating layer comprises a resin and a first filler;
the resin comprises a polyimide;
the first filler is present in a form of a primary particle or a secondary particle having a plurality of the primary particles aggregated;
the primary particle is a silica or alumina particle;
the secondary particle has a particle diameter of 0.03 μm or more and 5 μm or less; and
a percentage of a total area of the secondary particles to a sum of a total area of the primary particles and the total area of the secondary particles in a cross section of the insulated wire is 50% or more.

2. The insulated wire according to claim 1, wherein a percentage of the total area of the secondary particles having a particle diameter of 0.2 μm or more and 1 μm or less to the total area of the secondary particles in the cross section is 30% or more.

3. The insulated wire according to claim 1, wherein a percentage of a mass of the first filler to a mass of the insulating layer is 5% or more and 30% or less.

4. The insulated wire according to claim 1, wherein the polyimide is a polymer of an acid dianhydride and a diamine compound.

5. The insulated wire according to claim 4, wherein:
the acid dianhydride is either one or both of pyromellitic dianhydride and 3,3′,4,4′-biphenyltetracarboxylic dianhydride; and
the diamine compound is 4,4′-oxydianiline.

6. The insulated wire according to claim 5, wherein:
the acid dianhydride is composed of pyromellitic dianhydride and 3,3′,4,4′-biphenyltetracarboxylic dianhydride;
the pyromellitic dianhydride is contained in an amount of 10 mol % or more and 50 mol % or less; and
the 3,3′,4,4′-biphenyltetracarboxylic dianhydride is contained in an amount of 50 mol % or more and 90 mol % or less.

7. A method for producing the insulated wire according to claim 1, comprising, in the following order:
a first step of preparing the conductor and an insulating varnish;
a second step of coating the conductor on an outer peripheral surface thereof with the insulating varnish; and
a third step of baking the insulating varnish onto the conductor;
wherein:
the first step comprises step A of preparing the conductor and step B of preparing the insulating varnish;
in the step B, the insulating varnish is prepared by mixing a solvent, the first filler and the resin or a resin precursor thereof,
the solvent is N-methyl-2-pyrrolidone, N,N-dimethylacetamide or a mixture thereof, and the primary particle in the first filler has a particle diameter of 0.01 μm or more and 0.1 μm or less.

8. The method for producing an insulated wire according to claim 7, wherein the third step is performed at 300° C. or more and 700° C. or less for 0.1 minutes or more and 5 minutes or less.

9. The method for producing an insulated wire according to claim 7, wherein the insulating varnish has a resin solid content concentration of 10% by mass or more and 40% by mass or less.

10. The method for producing an insulated wire according to claim 7, wherein a percentage of the mass of the first filler to a mass of the resin solid content in the insulating varnish is 5% or more and 35% or less.
